(19) United States
(12) Patent Application Publication
(10) Pub. No.: US 2009/0194185 A1
(43) Pub. Date: Aug. 6, 2009

(54) HOSE-CLAMP ASSEMBLY

(76) Inventors: Ben F. Holt, Lexington, TN (US); Joel Hatchett, Henderson County, TN (US)

Correspondence Address: FLUID ROUTING SOULUTIONS , INC, 1955 ENTERPRISE DRIVE, ROCHESTER HILLS, MI, 48309, US

(21) Appl. No.: 12/026,029

(22) Filed: Feb. 5, 2008

(51) Int. Cl. F16L 3/137

(52) U.S. Cl. 138/106; 24/274 R

(57) ABSTRACT

A hose-clamp assembly including a hose having an outer surface, a clamp including a band, the band being tightenable about the outer surface of the hose, and a fastener including at least two bonding surfaces connected to the outer surface of the hose, the fastener defining a first elongated channel and a second elongated channel, the first elongated channel extending between the bonding surfaces and receiving a portion of the band therein, wherein the first elongated channel defines a first axis and the second elongated channel defines a second axis, the first axis being generally perpendicular to the second axis.

### BACKGROUND

The present application relates to hose-clamp assemblies and associated fasteners and, more particularly, to hose-clamp assemblies including a flexible fastener for securing a clamp to a hose.

In an effort to reduce costs and improve manufacturing efficiency, manufacturers, such as automotive original equipment manufacturer (“OEM”) customers, have asked that suppliers provide parts having multiple components in a pre-assembled condition. These requests eliminate packaging and simplify handling requirements for the manufacturer, thereby reducing final assembly time.

A common request in the automobile industry is that suppliers attach a pre-positioned clamp to a fuel fill hose, thereby allowing a single operator to install a relatively large hose-clamp assembly. Furthermore, where space limitations present obstacles, the inclusion of a pre-attached, pre-positioned clamp on a hose may eliminate the need for an operator to hold the clamp in place during installation. Therefore, a pre-attached, pre-positioned clamp may be particularly helpful in instances where it is not practical for the operator to hold the clamp due to space constraints.

Various attempts have been made to attach clamps to hoses. For example, clamps have been directly bonded to hoses using various adhesives, tapes, patches, mechanical clips and rivets. However, these attempts have presented various disadvantages. In particular, adhesives, tapes and patches all are susceptible to oil and other contaminants that negatively impact performance, while rivets and mechanical clips raise concerns about connection integrity and emissions.

Accordingly, there is a need for an improved hose-clamp assembly and associated fastener for connecting a clamp to a hose, wherein the fastener is flexible to accommodate hoses of various sizes.

### SUMMARY

In one aspect, the disclosed hose-clamp assembly may include a hose having an outer surface, a clamp including a band, the band being tightenable about the outer surface of the hose, and a fastener including at least two bonding surfaces connected to the outer surface of the hose, the fastener defining a first elongated channel and a second elongated channel, the first elongated channel extending between the bonding surfaces and receiving a portion of the band therein, wherein the first elongated channel defines a first axis and the second elongated channel defines a second axis, the first axis being generally perpendicular to the second axis.

In another aspect, the disclosed hose-clamp assembly may include an elongated, flexible hose having an outer surface, a clamp including a generally flat band, a screw housing and a worm screw disposed in the screw housing, the worm screw being engaged with the band to tighten the band about the outer surface of the hose in response to rotation of the worm screw, and a fastener including a first side, a second side and at least two bonding surfaces extending from the first side and connected to the outer surface of the hose, the bonding surfaces being contoured to closely engage the outer surface of the hose, the fastener defining a first elongated channel on the first side of the fastener and a second elongated channel on the second side of the fastener, the first elongated channel extending between the bonding surfaces and receiving a portion of the band therein, wherein the first elongated channel defines a first axis and the second elongated channel defines a second axis, the first axis being generally perpendicular to the second axis.

In another aspect, the disclosed fastener may include a body including a first side, a second side generally opposite of the first side, and at least two bonding surfaces extending from the first side, the bonding surfaces being contoured to closely engage a surface of a hose, the first side of the body defining a first elongated channel therein and the second side of the body defining a second elongated channel therein, the first elongated channel extending between the bonding surfaces, wherein the first elongated channel defines a first axis and the second elongated channel defines a second axis, the first axis being generally perpendicular to the second axis.

Other aspects of the disclosed hose-clamp assembly and associated fastener will become apparent from the following description, the accompanying drawings and the appended claims.

### BRIEF DESCRIPTION OF THE DRAWINGS

FIG. 1 is a top plan view of one aspect of the disclosed hose-clamp assembly;

FIG. 2 is a front perspective view of the fastener of the hose-clamp assembly of FIG. 1;

FIG. 3 is a side elevational view of the fastener of FIG. 2; and

FIG. 4 is a front elevational view of the fastener of FIG. 2.

### DETAILED DESCRIPTION

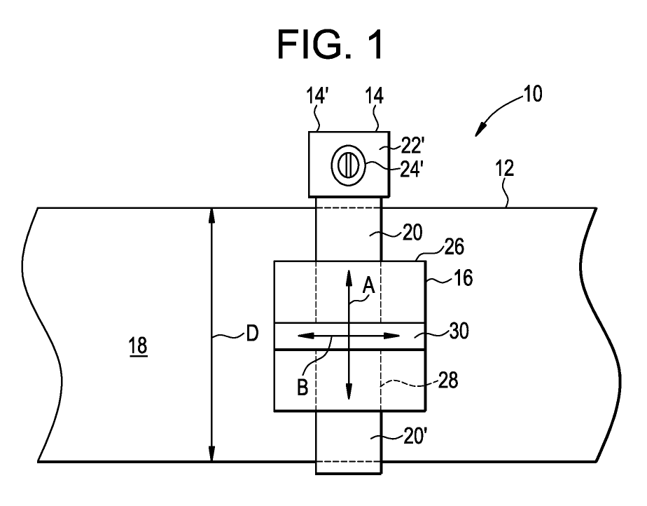

Referring to FIG. 1, one aspect of the disclosed hose-clamp assembly, generally designated 10, may include a hose 12, a clamp 14 and a fastener 16. The fastener 16 may secure the clamp 14 to the hose 12. The hose-clamp assembly 10 may be employed in or otherwise associated with a vehicle (not shown). However, those skilled in the art will appreciate that the hose-clamp assembly 10 may be useful in any application requiring a hose and a clamp for securing the hose.

The hose 12 may be any hose or like structure, such as a pipe or a tube, and may include an outer surface 18. For example, the hose 12 may be a flexible, polymeric automotive hose, such as a fuel fill hose. While a hose 12 having a generally circular cross-section would be typical, those skilled in the art will appreciate that hoses having various shapes and dimension may be used without departing from the scope of the present disclosure.

The clamp 14 may be any clamp having a band 20 capable of receiving the hose 12 and applying a clamping force to the hose 12 (e.g., a clamping force applied in the radial direction). In one example, as shown in FIG. 1, the clamp 14 may be a screw clamp 14′ and may include a generally flat band 20′, a screw housing 22′ and a worm screw 24′. The band 20′ may include a plurality of recesses or grooves (not shown). The worm screw 24′ may be rotateably received in the screw housing 22′ and may be engaged with the recesses or grooves in the band 20′ such that rotation of the worm screw 24′ relative to the screw housing 22′ facilitates corresponding tightening or relaxation of the band 20′ about the outer surface 18 of the hose 12.

At this point, those skilled in the art will appreciate that most any hose may be used as the hose 12 and most any clamp may be used as the clamp 14 with little or no modification and without departing from the scope of the present disclosure.

The fastener 16 may include a body 26 defining a first elongated channel 28, a second elongated channel 30 and bonding surfaces 32, 34. The first elongated channel 28 may be formed in a first side 36 of the body 26 and may extend between the bonding surfaces 32, 34 to define a first axis A. The second elongated channel 30 may be formed in a second side 38 of the body 26 and may define a second axis B. The first axis A may be generally perpendicular to the second axis B, as shown in FIG. 1.

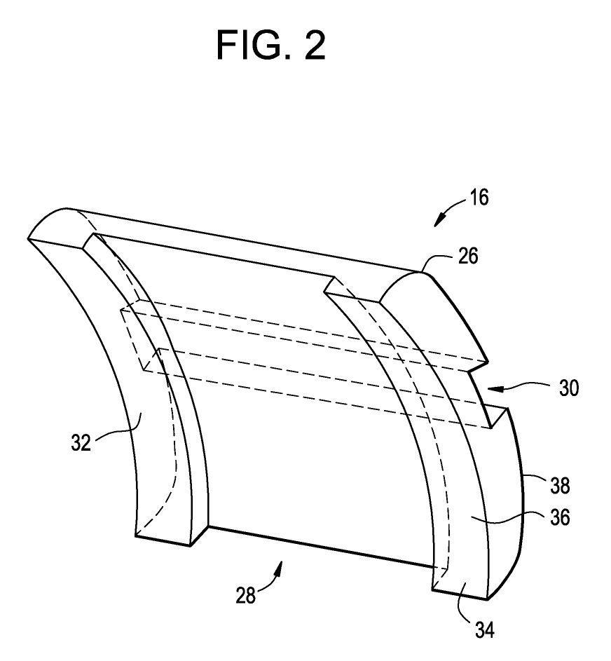

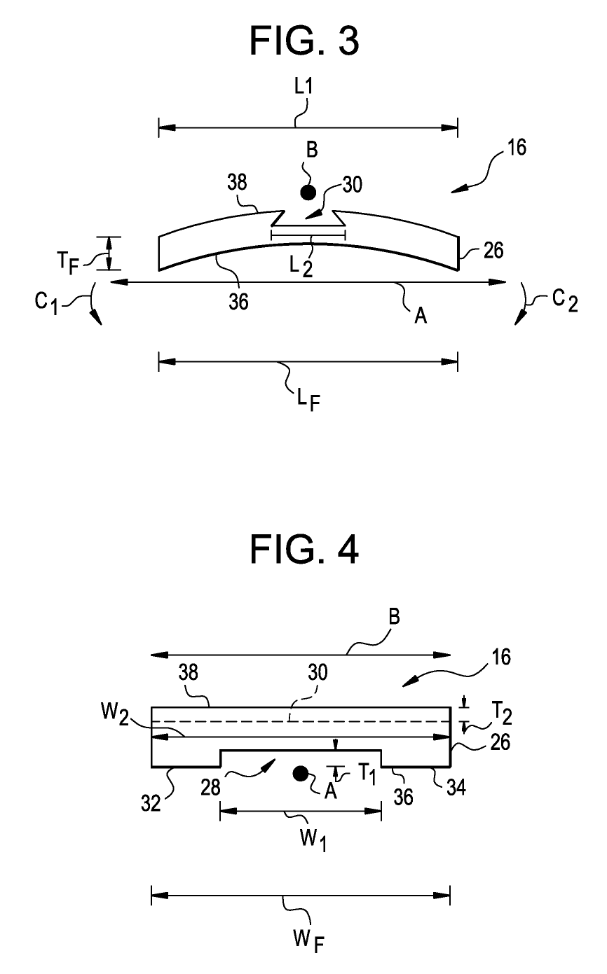

As shown in FIGS. 2-4, the fastener 16 may be formed as a generally annular flat band having an annular length L_{F} (FIG. 3), a width W_{F} (FIG. 4) and a thickness T_{F} (FIG. 3). The width W_{F} of the fastener 16 may be dictated by, among other things, the width of the band 20 of the clamp 14 intended to be used with the fastener 16. The annular length L_{F} of the fastener may be dictated by, among other things, the outer diameter D (FIG. 1) of the hose 12. The thickness T_{F} of the fastener 16 may be dictated by, among other things, manufacturing and space considerations. In one aspect, the thickness T_{F} of the fastener 16 may be substantially less than the annular length L_{F} and the width W_{F} of the fastener 16. In one example, the thickness T_{F} of the fastener 16 may be about 25 percent or less than the width W_{F} of the fastener 16. In another example, the thickness T_{F} of the fastener 16 may be about 18 percent or less than the width W_{F} of the fastener 16 However, those skilled in the art will appreciate that a fastener 16 may be formed having various shapes and dimensions without departing from the scope of the present disclosure.

The body 26 of the fastener 16 may be formed from any suitable material, such a metallic material, a non-metallic material, a polymeric material or the like. For example, the body 26 of the fastener 16 may be formed from a hard plastic, such as nylon or high-density polyethylene (HDPE).

The first elongated channel 28 may have an annular length L₁ (FIG. 3), a width W₁ (FIG. 4) and a thickness T₁ (FIG. 3). The annular length L₁ of the first elongated channel 28 may be generally equal to the length L_{F} of the fastener 16. The width W₁ and thickness T₁ of the first elongated channel 28 may be dictated by the width and thickness of the band 20 of the clamp 14 such that a portion of the band 20 may be closely received in the first elongated channel 28. At this point, those skilled in the art will appreciate that the size and shape of the first elongated channel may be dictated by the size and shape of the band 20 of the clamp 14. For example, when the band 20 has a generally flat, rectangular cross-section, the first elongated channel 28 may be provided with a generally flat, rectangular cross-section. However, when the band 20 has a generally round cross-section, the first elongated channel 28 may be provided with a generally round cross-section.

The bonding surfaces 32, 34 may be formed on the first side 36 of the body 26 and may have an axial length corresponding to the axial length L_{F} of the fastener 16. However, those skilled in the art will appreciate that the axial length of the bonding surfaces 32, 34 may be only a fraction of the axial length L_{F} of the fastener 16, or that the bonding surfaces 32, 34 may be formed as a plurality of discontinuous (or spaced apart) bonding surfaces. Furthermore, as best shown in FIG. 2, the bonding surfaces 32, 34 may have a curvature selected to ensure close engagement of the bonding surfaces 32, 34 with the outer surface 18 of the hose 12.

The second elongated channel 30 may have an annular length L₂ (FIG. 3), a width W₂ (FIG. 4) and a thickness T₂ (FIG. 4). The annular length L₂ of the second elongated channel 30 may be only a fraction of the annular length L₁ of the first elongated channel 28. In one example, the annular length L₂ of the second elongated channel 30 may be about 5 to about 30 percent of the annular length L₁ of the first elongated channel 28. In another example, the annular length L₂ of the second elongated channel 30 may be about 10 to about 20 percent of the annular length L₁ of the first elongated channel 28. The width W₂ of the second elongated channel 30 may be about equal to the width W_{F} of the fastener 16 (i.e., the second elongated channel 30 may extend across the entire width of the fastener 16). The thickness T₂ of the second elongated channel 30 may be only a fraction of the thickness T_{F} of the fastener 16. In one example, the thickness T₂ of the second elongated channel 30 may be about 10 to about 75 percent of the thickness T_{F} of the fastener 16. In another example, the thickness T₂ of the second elongated channel 30 may be about 30 to about 60 percent of the thickness T_{F} of the fastener 16.

Those skilled in the art will appreciate that annular length L₂ and/or the thickness T₂ of the second elongated channel 30 may be selected to permit flexing of the fastener 16 along the second elongated channel 30, as shown by arrows C₁ and C₂ in FIG. 3, thereby permitting modification of the curvature of the bonding surfaces. Furthermore, the cross-sectional shape (see FIG. 3) of the second elongated channel 30 may be selected to facilitate flexing. While the second elongated channel 30 is shown as having a generally trapezoidal cross-sectional shape in FIG. 3, those skilled in the art will appreciate that a variety of shapes may be used without departing from the scope of the present disclosure.

The hose-clamp assembly 10 may be assembled by placing the band 20 of the clamp 14 against the outer surface 18 of the hose 12 such that the band 20 is generally perpendicular to the hose 12. Then, the fastener 16 may be positioned over a portion of the band 20 such that the band 20 is generally aligned with and received within the first elongated channel 28 of the fastener 16 and the bonding surfaces 32, 34 are positioned against the outer surface 18 of the hose 12. Finally, the bonding surfaces 32, 34 may be securely connected to the outer surface 18 of the hose 12.

Those skilled in the art will appreciate that various techniques may be used for connecting the bonding surfaces 32, 34 of the fastener 16 to the outer surface 18 of the hose 12. In one aspect, the bonding surfaces 32, 34 of the fastener 16 may be connected to the outer surface 18 of the hose 12 with an adhesive (e.g., a cyanoacrylate glue). In another aspect, the bonding surfaces 32, 34 of the fastener 16 may be connected to the outer surface 18 of the hose 12 using a welding technique (e.g., ultrasonic welding). In another aspect, the bonding surfaces 32, 34 of the fastener 16 may be connected to the outer surface 18 of the hose 12 using fastening devices, such as staples, pins, rivets or the like.

Accordingly, in the assembled configuration (FIG. 1), the second elongated channel 30 of the fastener 16 may be axially aligned with the hose 12, thereby facilitating flexing of the fastener 16 to accommodate the curvature of the outer surface 18 of the hose 12, as shown by arrows C₁ and C₂ in FIG. 3. As such, a single fastener 16 may be used with hoses 12 of various sizes, thereby reducing manufacturing and tooling costs.

Although various aspects of the disclosed hose-clamp assembly have been shown and described, modifications may occur to those skilled in the art upon reading the specification. The present application includes such modifications and is limited only by the scope of the claims.

What is claimed is:

1. A hose-clamp assembly comprising:
a hose having an outer surface;
a clamp including a band, said band being tightenable about said outer surface of said hose; and
a fastener including at least two bonding surfaces connected to said outer surface of said hose, said fastener defining a first elongated channel and a second elongated channel, said first elongated channel extending between said bonding surfaces and receiving a portion of said band therein,
wherein said first elongated channel defines a first axis and said second elongated channel defines a second axis, said first axis being generally perpendicular to said second axis.

2. The assembly of claim 1 wherein said hose is a flexible hose.

3. The assembly of claim 1 wherein said band is a generally flat band.

4. The assembly of claim 1 wherein said clamp further includes a screw housing and a worm screw disposed in said screw housing, wherein said worm screw is engaged with said band.

5. The assembly of claim 1 wherein said bonding surfaces are contoured to closely engage said outer surface of said hose.

6. The assembly of claim 1 wherein said bonding surfaces are connected to said outer surface of said hose by an adhesive disposed therebetween.

7. The assembly of claim 1 wherein said bonding surfaces are connected to said outer surface of said hose by welds.

8. The assembly of claim 1 wherein said fastener is formed from a polymeric material.

9. The assembly of claim 1 wherein said first elongated channel has a curvature generally corresponding to a curvature of said hose.

10. The assembly of claim 1 wherein said first elongated channel has a width selected to closely receive a width of said band.

11. The assembly of claim 1 wherein said fastener includes a first side and a second side, said second side being generally opposite of said first side, wherein said first elongated channel is formed in said first side and said second elongated channel is formed in said second side.

12. The assembly of claim 1 wherein said second elongated channel opens radially outward from said hose.

13. A hose-clamp assembly comprising:
a hose having an outer surface;
a clamp including a generally flat band, a screw housing and a worm screw disposed in said screw housing, said worm screw being engaged with said band to tighten said band about said outer surface of said hose in response to rotation of said worm screw; and
a fastener including a first side, a second side and at least two bonding surfaces extending from said first side and connected to said outer surface of said hose, said bonding surfaces being contoured to closely engage said outer surface of said hose, said fastener defining a first elongated channel on said first side of said fastener and a second elongated channel on said second side of said fastener, said first elongated channel extending between said bonding surfaces and receiving a portion of said band therein,
wherein said first elongated channel defines a first axis and said second elongated channel defines a second axis, said first axis being generally perpendicular to said second axis.

14. The assembly of claim 13 wherein said hose is a flexible hose.

15. The assembly of claim 13 wherein said bonding surfaces are connected to said outer surface of said hose by an adhesive disposed therebetween.

16. The assembly of claim 13 wherein said bonding surfaces are connected to said outer surface of said hose by welds.

17. The assembly of claim 1 wherein said fastener is formed from a polymeric material.

18. The assembly of claim 1 wherein said first elongated channel has a curvature generally corresponding to a curvature of said hose.

19. The assembly of claim 1 wherein said first elongated channel has a width selected to closely receive a width of said band.

20. A fastener comprising a body including a first side, a second side generally opposite of said first side, and at least two bonding surfaces extending from said first side, said bonding surfaces being contoured to closely engage a surface of a hose, said first side of said body defining a first elongated channel therein and said second side of said body defining a second elongated channel therein, said first elongated channel extending between said bonding surfaces, wherein said first elongated channel defines a first axis and said second elongated channel defines a second axis, said first axis being generally perpendicular to said second axis.
